(19) United States
(12) Patent Application Publication
(10) Pub. No.: US 2011/0090851 A1
(43) Pub. Date: Apr. 21, 2011

(54) Method and System for Transmission of Fragmented Packets on a Packet-Based Communication Network

(75) Inventors: Mohamed Khalil, Murphy, TX (US); Amir Saghir, Allen, TX (US); Ahmad Muhanna, Richardson, TX (US); Haseeb Akhtar, Garland, TX (US)

(73) Assignee: NORTEL NETWORKS LIMITED, St. Laurent, QC (CA)

(21) Appl. No.: 12/991,837

(22) PCT Filed: May 15, 2009
(86) PCT No.: PCT/US2009/003046

§ 371 Date: Nov. 9, 2010

Related U.S. Application Data
(60) Provisional application No. 61/053,485, filed on May 15, 2008.

(51) Int. Cl. H04W 4/00

(52) U.S. Cl. 370/328

(57) ABSTRACT

The present invention provides a method and system for the identification and discovery of the lowest maximum transmission unit (MTU) size for transmission packets on some or all of the transmission path nodes. Different methods and protocols are described in the present patent application to support the identification and discovery of the lowest maximum transmission unit (MTU) size for fragmented transmission packets.

### RELATED APPLICATION DATA

This application is related to Provisional Patent Application Ser. No. 61/053,485 filed on May 15, 2008, and priority is claimed for this earlier filing under 35 U.S.C. §119(e). The Provisional patent application is also incorporated by reference into this utility patent application.

### TECHNICAL FIELD OF THE INVENTION

A method and system for the transmission of fragmented packets on a packet-based communication network.

### BACKGROUND OF THE INVENTION

IP-based mobile system includes at least one mobile node on a wireless communication system. The term “mobile node” includes a mobile communication unit, and, in addition to the mobile node, the communication system has a home network and a foreign network. The mobile node may change its point of attachment to these networks, but the mobile node will always be associated with a single home network for IP addressing purposes. The home network has a home agent and the foreign network has a foreign agent—both of which control the routing of information packets into and out of their network.

The mobile node, home network, and foreign network may be called other names depending on the nomenclature used on any particular network configuration or communication system. For instance, a “mobile node” is sometimes referred to as user equipment, mobile unit, mobile terminal, mobile device, or similar names depending on the nomenclature adopted by particular system providers.

A “mobile node” encompasses PC's having cabled (e.g., telephone line (“twisted pair”), Ethernet cable, optical cable, and so on) connectivity to the wireless network, as well as wireless connectivity directly to the cellular network, as can be experienced by various makes and models of mobile terminals (“cell phones”) having various features and functionality, such as Internet access, e-mail, messaging services, and the like. The term “mobile node” also includes a mobile communication unit (e.g., mobile terminal, “smart phones,” nomadic devices such as laptop PCs with wireless connectivity).

A home agent may be referred to as a Home Agent, Home Mobility Manager, Home Location Register, Local Mobility Agent, or Packet Data Network. And, a foreign agent may be referred to as a Mobility Agent Gateway, Serving Gateway, Serving Mobility Manager, Visited Location Register, and Visiting Serving Entity. Foreign networks can also be called serving networks. The terms Mobile Node, Home Agent and Foreign Agent are not meant to be restrictively defined, but could include other mobile communication units or supervisory routing devices located on the home or foreign networks.

### Registration of Mobile Node

The mobile node will always be associated with its home network and sub-network for IP addressing purposes and will have information routed to it by routers located on the home and foreign network. If the mobile node is located on its home network, information packets will be routed to the mobile node according to the standard addressing and routing scheme.

If the mobile node is visiting a foreign network, however, the mobile node obtains appropriate information from an agent advertisement, and transmits a registration request message (sometimes called a binding update request) to its home agent through the foreign agent. The registration request message will include a care-of address for the mobile node. A registration reply message (also called a binding update acknowledge message) may be sent to the mobile node by the home agent to confirm that the registration process has been successfully completed.

As part of the registration process, the mobile node maintains connectivity with the home agent or local mobility anchor through the use of a “care-of address.” This care-of address is registered with the home agent or local mobility anchor in a table, sometimes called a Binding Cache Entry Table. The registered care-of address identifies the foreign network where the mobile node is located, and the home agent or local mobility anchor uses this registered care-of address to forward information packets to the foreign network for subsequent transfer onto the mobile node.

### Mobile Node Mobility

The mobile node may change its point of attachment to the Internet through these networks, but the mobile node will always be associated with a single home network for IP addressing purposes. The home network includes a home agent and the foreign network includes a foreign agent—both of which control the routing of information packets into and out of their network. A mobile node may transition and move from one foreign network to another foreign network. Each foreign network is identified by a different care-of address, so the transition of the mobile node from one foreign network to a new foreign network requires a modification of the care-of addresses registered for the mobile node at the home agent or local mobility anchor.

If the home agent or local mobility anchor receives an information packet addressed to the mobile node while the mobile node is located on a foreign network, the home agent or local mobility anchor will transmit the information packet to the mobile node's current location on the foreign network using the applicable care-of address. This is accomplished by forwarding the information packet to the care-of address where the foreign network will receive the information packet, and forward the information packet to the mobile node on the foreign network. During these communications, the transmission of communication packets between the foreign network and the home agent or local mobility anchor will be performed using a tunneling communication protocol.

The registered care-of address identifies the foreign network where the mobile node is located, and the home agent or local mobility anchor also uses this registered care-of address to forward information packets received from the mobile node located on the foreign network. In this situation, the mobile node may transmit information and communication packets back through the foreign agent to the home agent or local mobility anchor for further processing and transmission to other nodes on the system, such as the correspondence node. The source of the information packets will be identified on the mobile node's packets as the mobile node's care-of address.

The home agent or local mobility anchor will confirm that the mobile node's communications are being transmitted from a valid care-of address for the mobile node before routing, processing, and further transferring the packets received from the mobile node. If the home agent receives an information packet that does not have a valid care-of address as its source, the packets will not be processed further. If the care-of address is valid, the information packet will then be forwarded and routed to the destination by the home agent or local mobility anchor. These communications are sometimes referred to a “tunneled” communication between the foreign network and the home network.

### Fragmentation of Tunneled Packet Transmissions

Tunneling is the basic methodology in IP communication by which a data packet is routed to the appropriate internet node through an intermediate internet address. Typically, a data packet with network routing is “encapsulated” by IP address information. Encapsulation involves adding an outer IP header to the original IP header fields. In this manner, a “tunnel” can be constructed. The outer IP header contains a source and destination IP address—the “endpoints” of the tunnel. The inner IP header source and destination addresses identify the original sender and destination addresses.

The original sender and recipient addresses remain unchanged, while the new “tunnel” endpoint addresses are grafted upon the original data packet. This alters the original IP routing by delivering the data packet to an intermediate destination node (in this case the Foreign Agent), where it is “decapsulated” or “de-tunneled” yielding the original data packet and routing. The packet is then delivered according to the destination found in the original IP address.

The important concept to keep in mind is that the “tunnel” is established by encapsulating a data packet containing the original IP address of the Mobile Node and an IP source address with the intermediate routing IP address (i.e. care-of address) of the foreign network. After the Foreign Agent decapsulates the data packet, the Foreign Agent in turn routes the data packet using the assigned Home Address of the Mobile Node found in the original data packet.

During the transmission of encapsulated transmission packets in the tunneling communication, the encapsulated transmission packets are transmitted through the home network, foreign network and intermediate routers and networks until it reaches the mobile node. Each of these steps in the transmission path can be considered a separate node in the transmission path. There may be limitations on the size of packeted transmissions that can be transmitted to or from the home network, foreign network or intermediate routers and networks. Because the size of the encapsulated transmission packets is not fixed, the size may exceed these packet size limitations.

In order to comply with these maximum size requirements, the various nodes on the transmission path may “fragment” the encapsulated transmission packets into separate smaller sized packets that can be transmitted between nodes on the transmission path in compliance with the maximum packet size limitations. Fragmentation performed by nodes in the transmission path often requires that further encapsulation headers be added to the fragmented packets, which introduces additional overhead and consumes additional system resources to assemble and transport such fragmented packet transmissions.

Fragmentation performed by the internal nodes in the transmission path can significantly increase the overhead and use of system resources, which can be avoided if the initial fragmentation performed at the home network fragments the packet size at or below a lowest maximum transmission unit (MTU) size for the nodes on the transmission path. It is a primary objective of the present invention to reduce the overhead and system resource usage by discovering the lowest maximum transmission unit (MTU) size for tunneled communications to and from a mobile node for all or some of the transmission path to the mobile node.

### SUMMARY OF THE INVENTION

The present invention provides a method and system for the identification and discovery of the lowest maximum transmission unit (MTU) size for transmission packets on some or all of the transmission path nodes. Different methods and protocols are described in the present patent application to support the identification and discovery of the lowest maximum transmission unit (MTU) size for fragmented transmission packets.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a mobile IP-based communication system as used in the present invention,

FIG. 2 is a graphic depiction of encapsulation/external fragmentation of a transmission packet;

FIG. 3 is a graphic depiction of internal fragmentation/encapsulation of a transmission packet;

FIG. 4-7 are protocols according to the present invention for discovery of the lowest maximum transmission unit for an exemplary set of nodes (foreign agent, intermediate router, and home agent) in the transmission path.

### DETAILED DESCRIPTION OF THE PREFERRED EMBODIMENTS

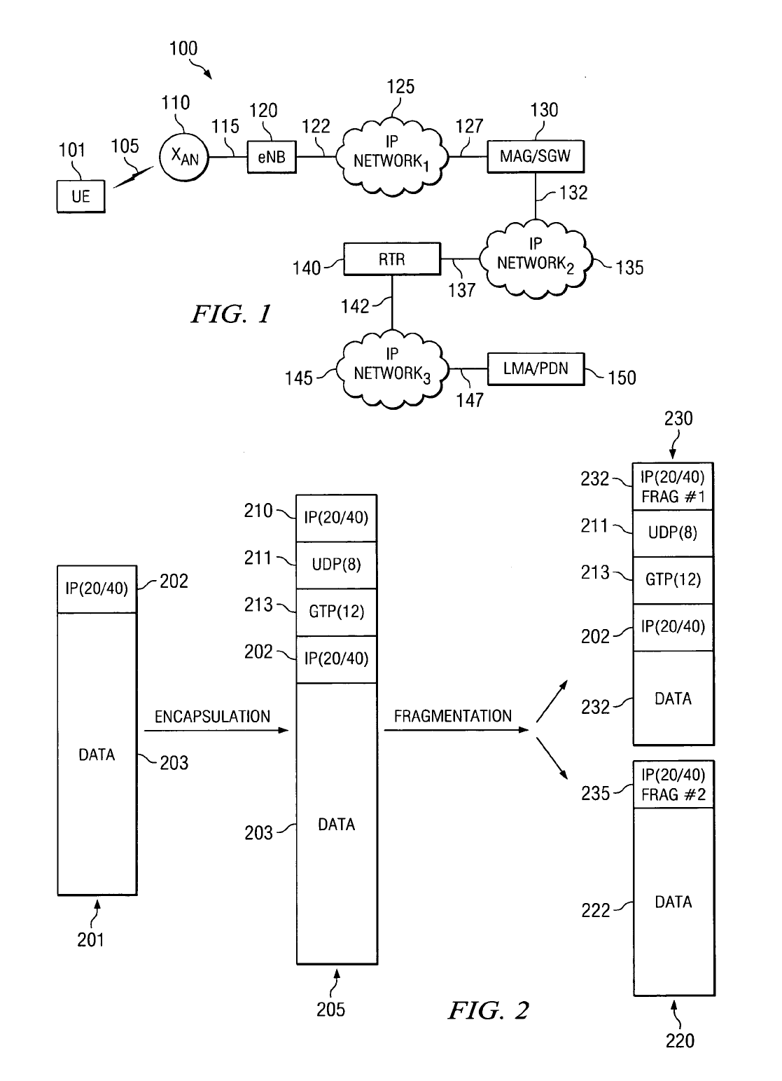

In FIG. 1, the overall architecture of the IP-based mobile system 100 is shown with user equipment 101 or mobile node 101 coupled to a transceiver station (Xan) 110 by a wireless connection. The connection to the mobile node may also be a land based connection for the purposes of this invention.

The transceiver station (Xan) 110 is coupled to a basestation location (eNB) 120 by connection 115, and the basestation location (eNB) 120 is coupled to IP Network1 125 by connection 122. The IP Network1 125 is coupled to the foreign agent MAG/SGW 130 on the foreign network by connection 127, and the foreign network MAG/SGW 130 is coupled to the IP Network2 135 by connection 132.

The IP Network2 135 is coupled to an intermediate router RTR 140 by connection 137. The intermediate router RTR 140 is coupled to the IPNetwork3 by connection 142, and the IPNetwork3 is connected to the home agent LMA/PDN 150 on the home network by connection 142. The present invention is described with respect to the downlink transmissions from the home agent LMA/PDN 150 to the mobile node 101, but the present invention could be applied equally to uplink transmissions from the mobile node 101 to home agent LMA/PDN 150.

In the present invention, the home agent LMA/PDN 150 encapsulates a transmission packet 201 shown in FIG. 2 for transmission to the mobile node 101. The transmission packet 201 is shown with IP header 202 and data payload 203, and once encapsulated the transmission packet 205 has an encapsulation IP header 210, UDP designation 211, GTP designation 213, IP header 202 and data payload 203. If the home agent LMA/PDN 150 (or the other nodes on the network) conducts external fragmentation of the encapsulated packet 205, the home agent LMA/PDN 150 will generate fragmented transmission packets 230 and 220. Fragmented transmission packet 230 will have a fragmented encapsulated IP header 232, UDP designation 211, GTP designation 213, IP header 202 and a portion of the data payload 203 designated as data payload 232. The second fragmented transmission packet 220 will have the fragmented encapsulated IP header 235 and a second portion of the data payload 203 designated as data payload 222.

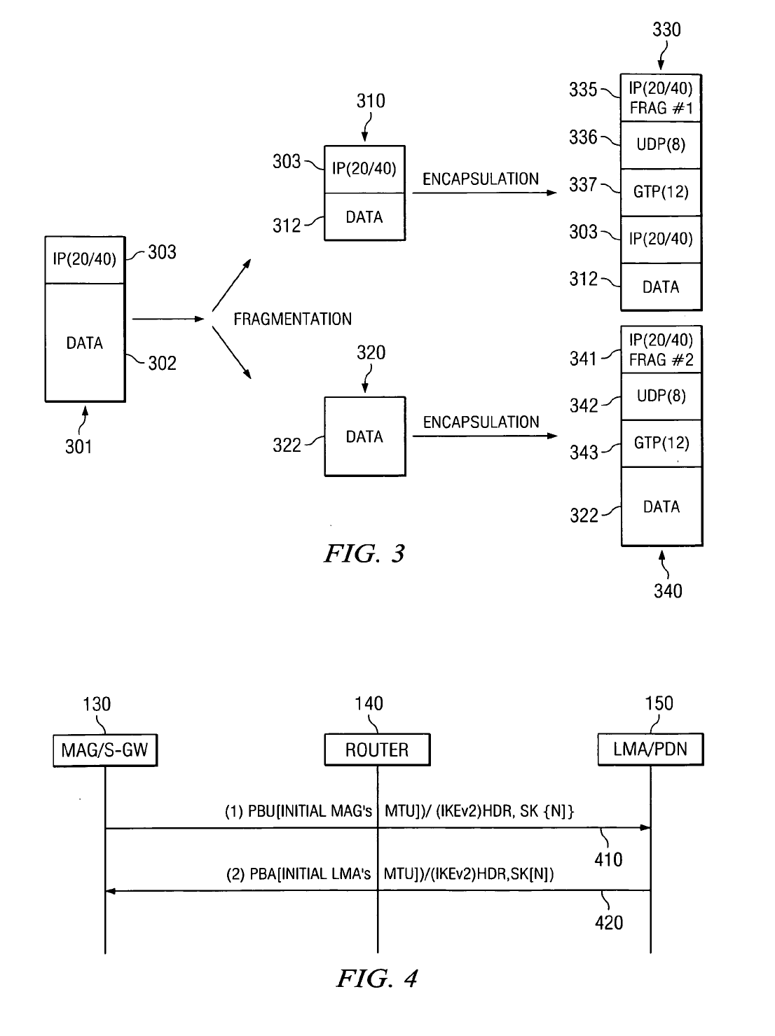

In the present invention, if internal fragmentation is conducted by the home agent LMA/PDN 150 (or the other nodes on the network), the fragmentation occurs prior to encapsulation. The transmission packet 301 shown in FIG. 3 has an IP header 303 and a data payload 302, and upon fragmentation, the transmission packets 310 and 322 are generated. Transmission packet 310 has the IP header 303 and a portion of the data payload 302 designated as data payload 312.

The second fragmented transmission packet 320 has a second portion of the data payload 302 designated as data payload 322. After fragmentation, the fragmented transmission packets 310 and 322 are encapsulated and shown as encapsulated transmission packets 330 and 340. The encapsulated transmission packet 330 has an encapsulation IP header 335, UDP designation 336, GTP designation 337, IP header 303 and data payload 312. The encapsulated transmission packet 340 has an encapsulation IP header 341, UDP designation 342, GTP designation 343, and data payload 322.

The methods of internal and external fragmentation each have various advantages and disadvantages. Both fragmentation methods are shown to increase the overhead for each transmission packet by increasing the header information that will need to be processed. Further, external fragmentation has overhead added to each fragmented transmission packet 230 and 220, but transmission packet 220 does not possess sufficient header information to determine how the transmission packet 220 should be handled (QoS) and prioritized. (e.g. latency, bandwidth, priority)

In order to make that determination, all the fragmented transmission packets will need to be de-fragmentized or re-assembled with the lead fragmented transmission packet 230. With internal fragmentation, each fragmented transmission packet 330 and 340 has the header information sufficient to make these handling and prioritization determinations so there is no need to de-fragment or re-assemble all the fragmented transmission packets. But, by including additional encapsulation header information on each fragmented transmission packet 330 and 340, there is a substantial increase in the overhead of these transmission packets (and decrease in the effective data throughput) for the system, which wastes system resources.

Traffic parameters and application traffic characteristic parameters were analyzed to determine what is the best type of fragmentation to use on the system. The results at Table I shown below show the results of analysis for different application traffic such as traffic involved with interactive gaming, VoIP, Video Conference, streaming media, information technology, media content and WAP. The results of traffic parameter research for FTP, web browsing/HTTP, video streaming, VoIP, and interactive gaming are shown in Table II.

TABLE I
Application Tra [symbol] Characteristic Parameters

| | | | | | | | | A [symbol] | |
|---|---|---|---|---|---|---|---|---|---|
| Application | | Through [symbol] ) | | Mean p [symbol] at | Mean Duration | | | (by [symbol] ) | |
| Class | Applications | Min | Max | cell size [symbol] | (B [symbol] ) | DLF | ULF | DIL | UIL |
| Interactive | Interactive Gaming | [symbol] | [symbol] 5 | | 3000 | 1 | 0.2 | 300 | 300 |
| Gaming | | | | | | | | | |
| VoIP, [symbol] | VoIP | 3 | 64 | | 120 | 1 | 1 | 40 | 40 |
| Conference | Video Te [symbol] | 32 | 3 [symbol] 4 | | 1500 | 1 | 1 | 500 | 500 |
| Streaming Mode | M [symbol] | 5 | 125 | | [symbol] | 1 | 0 | 1500 [symbol] | 40 |
| | Video Clips ( [symbol] ) | 20 | 364 | | 3000 | 1 | 0 | 1530 [symbol] | 40 |
| | Movie Streaming (PTY) | 300 | 3803 | | 3800 | 1 | 0 | 1500 [symbol] | 40 |
| | | | ( [symbol] | | | | | | |
| | | | HDTV) | | | | | | |
| Information | IM | 10 | 20 | 0.088 | 40 | 1 | 0.07 | 200 | 200 |
| Technology | Web Browsing | 500 | | 54.3 | Mean Interval: 30 | 1 | 0 | 350 | 40 |
| | | | | | seconds | | | | |
| | E [symbol] | 500 | | 10.7 | | 1 | 0.5 | 500 | 400 |
| | E [symbol] | 500 | | 162 | | 1 | 0.5 | 1000 | 1000 |
| | T [symbol] | 10 | 20 | 0.5 | | 1 | 0 | 1000 | 200 |
| [symbol] Control | [symbol] , Movie Download | 1000 | | 2000 | Mean Interval: 180 | 1 | 0.1 | 1500 [symbol] | 40 |
| | (FTP) | | | | seconds | | | | |
| | PSP | 500 | | 1000 | | 1 | 1 | 200 | 200 |
| WAP | | 10 | 20 | 0.512 | | 1 | 0 | 200 | 200 |

[symbol]

indicates data missing or illegible when filed

TABLE II

| Application | Traffic Parameters | Outage Limit and Definition (performance reference) | [symbol] |
|---|---|---|---|
| FTP | File size: Mean 2M bytes (max 5M bytes) | 2% outage based on user packet call throughput < P | 10% |
| | Reading time: Mean 180 seconds | P = 128 Kbps for BW > 2.5 MHz | |
| | | No delay not throughput guarantees | |
| Web Browsing/ | The total mean object file size is about | 2% outage based on user packet call throughput < Q | 20% |
| HTTP | 64k byte | Q = 128 Kbps for BW < 2.5 MHz | |
| | Reading time; Mean −30 seconds | No delay not throughput guarantees | |
| Video | 500k bps source could be appiled | 2% outage based on user having >2% dropped | 20% |
| Streaming | Typical packet size 1500 byte (DL) | packets (recommended packet loss rates in the range | |
| | Long duration 3000 seconds | of 10 [symbol] | |
| | | Maximum acceptable jitter delay factor (DF) | |
| | | [ [symbol] ] = 50 ms latency <200 ms for IPTV; | |
| | | Delay tolerated of streaming at stored video: −5 secs | |
| | | and −400 ms for Real-time interactive video: | |
| VoIP | Average throughput 25 kbps | 2% outage based on user having <98% of its speech | 30% |
| | Average packet size 40 byte payload with | frames delivered successfully within [40] ms | |
| | 20 ms frames | (air interface delay). | |
| | Average duration 120 seconds | Consecutive speech frames erased < [0.05]% of time | |
| | | Recommended upper limit for end to end | |
| | | delay −150 ms | |
| Interactive | Minimum 50 kbps throughput | A mobile network gaming user is in outage if the | 20% |
| Gaming | Long duration 3600 seconds | average pocket delay >60 ms | |
| | Average packet size 300 byte | Maximum delay to all uplink packets: 160 ms | |
| | | Jittering Similar to real-time interactive video | |

[symbol]

indicates data missing or illegible when filed

Different models of traffic capacity and flow for different fragmentation protocols (internal vs. external) were analyzed, where a maximum transmission unit size was dynamically allocated (dynamic) or statically designated (static). The models for the transmission systems included weighting the processing costs associated with the home agent LMA/PDN 150, foreign agent MAG/SGW 130, the basestation eNB 120 and the mobile node 101, where each of these nodes is allocated a processing cost associated with assembly, processing, fragmentation and routing.

Additionally, two intermediate routers, one between the home agent LMA/PDN 150 and the foreign agent MAG/SGW 130 and the other between the foreign agent MAG/SGW 130, and the basestation eNB 120 were allocated a processing cost. The results of the modeling in the first and second scenario where the MTU for the intermediate routers was the lowest maximum of 1000B and 1500B packet size is shown below in Table III and IV.

TABLE III

| | Gain | | | | |
|---|---|---|---|---|---|
| | PGW | R1 CPU | SGW | R2 CPU | eNB |
| LTE Model # | CPU | cost | CPU | cost | CPU |
| 1 (Static MTU: Ext Frag) | 0% | 0% | 0% | 0% | 0% |
| 2 (Dyn MTU: Ext Frag) | 0% | 100% | 16% | 100% | 8% |
| 3 (Static MTU: Int Frag) | −8% | 0% | 0% | 0% | 8% |
| 4 (Dyn MTU: Int Frag) | −8% | 100% | 32% | 100% | 25% |
| Traffic mix | Comparing Model 4 with Model 1 | | | | |
| 10% | −0.8% | 10.0% | 3.2% | 10.0% | 2.5% |
| 20% | −1.5% | 20.0% | 6.5% | 20.0% | 4.9% |
| 30% | −2.3% | 30.0% | 9.7% | 30.0% | 7.4% |
| 40% | −3.1% | 40.0% | 12.9% | 40.0% | 9.8% |
| 50% | −3.8% | 50.0% | 16.1% | 50.0% | 12.3% |

TABLE IV

| | Gain | | | | |
|---|---|---|---|---|---|
| | PGW | R1 CPU | SGW | R2 CPU | eNB |
| LTE Model # | CPU | cost | CPU | cost | CPU |
| 1 (Static MTU: Ext Frag) | 0% | 0% | 0% | 0% | 0% |
| 2 (Dyn MTU: Ext Frag) | 0% | 0% | 0% | 0% | 0% |
| 3 (Static MTU: Int Frag) | −8% | 0% | 19% | 0% | 18% |
| 4 (Dyn MTU: Int Frag) | −8% | 0% | 19% | 0% | 18% |
| Traffic mix | Comparing Model 4 with Model 1 | | | | |
| 10% | −0.8% | 0.0% | 1.9% | 0.0% | 1.8% |
| 20% | −1.5% | 0.0% | 3.8% | 0.0% | 3.6% |
| 30% | −2.3% | 0.0% | 5.8% | 0.0% | 5.4% |
| 40% | −3.1% | 0.0% | 7.7% | 0.0% | 7.1% |
| 50% | −3.8% | 0.0% | 9.6% | 0.0% | 8.9% |

The processor weightings for the home agent LMA/PDN 150, the foreign agent MAG/SGW 130 and the mobile node 101 processors were increased slightly for another set of modeling scenarios. The results of the modeling in the third and fourth scenario where the MTU for the intermediate routers was the lowest maximum of 1000B and 1500B packet size is shown below in Table V and VI.

TABLE V

| | Gain | | | | |
|---|---|---|---|---|---|
| | PGW | R1 CPU | SGW | R2 CPU | eNB |
| LTE Model # | CPU | cost | CPU | cost | CPU |
| 1 (Static MTU: Ext Frag) | 0% | 0% | 0% | 0% | 0% |
| 2 (Dyn MTU: Ext Frag) | 0% | 0% | 0% | 0% | 0% |
| 3 (Static MTU: Int Frag) | −6% | 0% | 0% | 0% | 12% |
| 4 (Dyn MTU: Int Frag) | −6% | 0% | 0% | 0% | 12% |
| Traffic mix | Comparing Model 4 with Model 1 | | | | |
| 10% | −0.6% | 0.0% | 0.0% | 0.0% | 1.2% |
| 20% | −1.3% | 0.0% | 0.0% | 0.0% | 2.5% |
| 30% | −1.9% | 0.0% | 0.0% | 0.0% | 3.7% |
| 40% | −2.6% | 0.0% | 0.0% | 0.0% | 4.9% |
| 50% | −3.2% | 0.0% | 0.0% | 0.0% | 6.1% |

TABLE VI

| | Gain | | | | |
|---|---|---|---|---|---|
| | PGW | R1 CPU | SGW | R2 CPU | eNB |
| LTE Model # | CPU | cost | CPU | cost | CPU |
| 1 (Static MTU: Ext Frag) | 0% | 0% | 0% | 0% | 0% |
| 2 (Dyn MTU: Ext Frag) | 0% | 100% | 14% | 100% | 8% |
| 3 (Static MTU: Int Frag) | −6% | 0% | −14% | 0% | 4% |
| 4 (Dyn MTU: Int Frag) | −6% | 100% | 14% | 100% | 19% |
| Traffic mix | Comparing Model 4 with Model 1 | | | | |
| 10% | −0.6% | 10.0% | 1.4% | 10.0% | 1.9% |
| 20% | −1.3% | 20.0% | 2.8% | 20.0% | 3.6% |
| 30% | −1.9% | 30.0% | 4.2% | 30.0% | 5.7% |
| 40% | −2.6% | 40.0% | 5.6% | 40.0% | 7.6% |
| 50% | −3.2% | 50.0% | 6.9% | 50.0% | 9.5% |

For combinations of fragmentation are modeled above using slightly different MTU sizes for the intermediate routers. External and internal fragmentation were modeled with the combination of either static or dynamic allocation of the MTU size. By static MTU allocation, the maximum transmission unit size would be set by the system administrator, which is not deemed to optimize efficiency of the transmissions over the system. By dynamic MTU allocation, the MTU size would be set by the lowest maximum MTU size for any two nodes on the transmission path.

The modeling analysis demonstrated several key recommendations. First, using a dynamic allocation of the MTU size improves system capacity, and dynamic MTU allocation is required in IPv6 protocols. Second, if the nodes support internal fragmentation and external fragmentation can be avoided in the intermediate routers, system capacity will be improved. Third, the optimized model for transmissions is the use of internal fragmentation with dynamic MTU allocation, which increases the header overhead by 2-4% but reduces the processor (e.g. SGW and eNB) costs associated with assembly and fragmentation significantly and thereby reduces transmission time (e.g. total delay savings) by 10-20 msec.

If the packet can be initially fragmented in a manner to reduce fragmentation at the intermediate nodes, the system capacity will be improved. The optimal goal would be to initially fragment the packets into sizes less than the lowest maximum transmission unit (MTU) size, so that the intermediate nodes will not need to further fragment the packets, the system processing costs will be lowered, and the transmission time (delays) will be minimized.

In order to initially fragment the transmission packets into packets of a size less than the lowest MTU size, the lowest MTU size for the nodes on the transmission path must be discovered. The present invention accomplishes that goal in several different embodiments which are described with respect to three basic nodes on the transmission path—foreign agent LMA/PDN 150, intermediate router 140, and home agent MAG/SGW 130. The invention can be easily extended to include all nodes on the transmission path, all combinations of two nodes on the transmission path, uplink or downlink directions of communications along the transmission path, and external or internal fragmentation processing schemes.

The present invention is described in the embodiment described in FIG. 4 as follows. The foreign agent MAG/SGW 130 transmits a proxy binding update message 410 to the home agent LMA/PDN 150 with the foreign agent's maximum transmission unit (MTU) size, which is the maximum size of packet that can be received and processed by the foreign agent MAG/SGW 130 without requiring that foreign agent entity to further fragment the transmission packet during processing and transmission.

The home agent MAG/SGW 130 receives and accumulates comparable maximum transmission unit (MTU) information from other proxy binding update messages transmitted from the other routers and nodes on the transmission path, and uses the accumulated MTU information to calculate the lowest maximum transmission unit (MTU) for all the nodes on the transmission path. The home agent LMA/PDN 150 sends the foreign agent MAG/SGW 130 (and other nodes on the transmission path) a proxy binding update response message 420, which includes the lowest maximum transmission unit (MTU) for the nodes on the transmission path.

The home agent LMA/PDN 150 and/or the foreign agent MAG/SGW 130 then sets its MTU size based on this lowest maximum transmission unit for all the nodes on the transmission path, so that transmission packets processed by the home agent LMA/PDN 150 and/or foreign agent MAG/SGW 130, respectively, will be fragmented into a size that will not require any further processing or fragmentation by the intermediate entities and routers on the transmission path. This will eliminate the need for intermediate fragmentation processing along the transmission path, which will result in less processing delays and system resource usage and greater transmission throughput on the system.

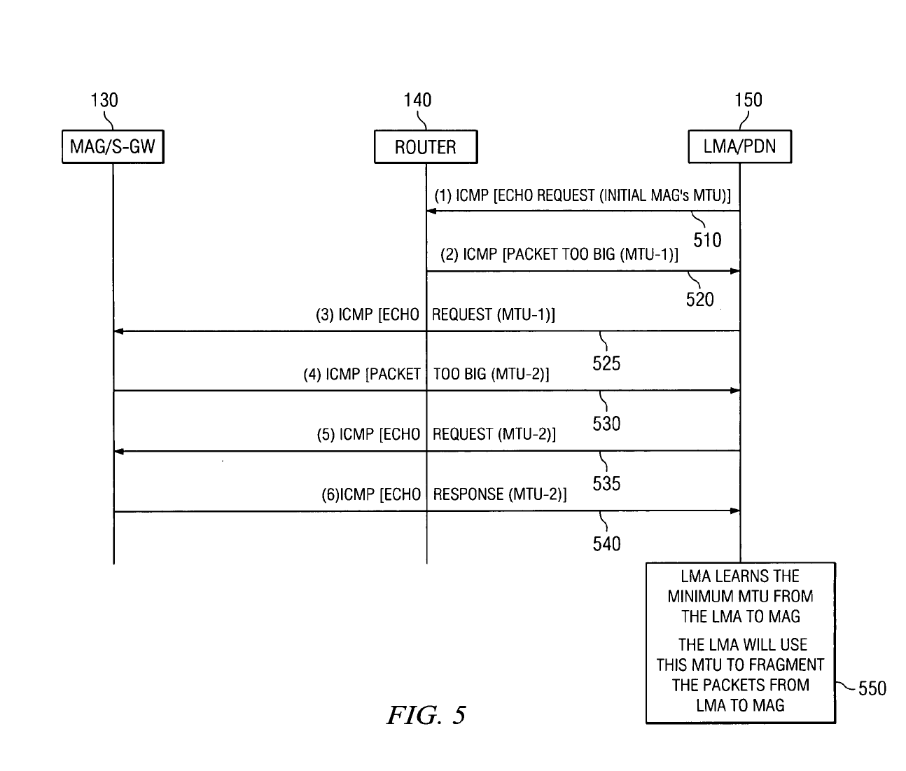

As an alternative embodiment shown in FIG. 5, the home agent LMA/PDN 150 may determine what the lowest MTU value for intermediate router 140 by sending an echo transmission request 510 to the intermediate router 140 with an initial MTU parameter value of the maximum transmission unit (MTU). This initial MTU parameter value will be derived from information set by the foreign agent MAG/SGW 130, or it may be set as a predetermined high MTU value.

The intermediate router 140 responds to the home agent LMA/PDN 150 with an echo (“packet too big”) response message 520 if the MTU parameter value in the echo request message is greater than the lowest MTU value that can be accommodated by the intermediate router without requiring that intermediate router to further fragment the transmission packet during processing and transmission. If the home agent LMA/PDN 150 receives this type of echo response 520, it will re-send its echo transmission message 510 with a lower MTU parameter value. If the MTU parameter value in the echo transmission 510 is equal to or less than MTU value that can be accommodated by the intermediate router 140 without requiring that intermediate router to further fragment the transmission packet during processing and transmission, the intermediate router 140 will not send an echo (“packet too big”) response message to the home agent LMA/PDN 150. In this manner, the home agent LMA/PDN 150 will be able to determine the lowest MTU value for the intermediate router 140 when the home agent LMA/PDN 150 does not receive an echo response from any intermediate router 140.

After not receiving an echo response from the intermediate router 140, the home agent LMA/PDN 150 will transmit similar echo request messages to the other nodes on the transmission path, such as to the foreign agent MAG/SGW 130 in echo request 525. The foreign agent MAG/SGW 130 responds to the home agent LMA/PDN 150 with an echo (“packet too big”) response message 530 if the MTU parameter value in the echo request message is greater than the MTU value that can be accommodated by the foreign agent MAG/SGW 130 without requiring that foreign agent MAG/SGW 130 to further fragment the transmission packet during processing and transmission.

If the home agent LMA/PDN 150 receives this type of echo response, it will re-send its echo transmission message 535 with a lower MTU parameter value. If the MTU parameter value in the echo transmission 535 is equal to or less than MTU value that can be accommodated by the foreign agent MAG/SGW 130 without requiring that foreign agent MAG/SGW 130 to further fragment the transmission packet during processing and transmission, the foreign agent MAG/SGW 130 will not send an echo (“packet too big”) response message to the home agent LMA/PDN 150. Otherwise, the foreign agent MAG/SGW 130 will respond with an echo response 540. In this manner, the home agent LMA/PDN 150 will be able to determine the lowest maximum MTU value for the foreign agent MAG/SGW 130 when it does not receive an echo response from the foreign agent MAG/SGW 130.

After all the nodes in the transmission path have been polled by the home agent LMA/PDN 150, the home agent LMA/PDN 150 will be able to determine the lowest maximum MTU value for the nodes in the transmission path when the home agent LMA/PDN 150 does not receive an echo response from the foreign agent MAG/SGW 130 or any other intermediate routers 140 on the transmission path. The home agent LMA/PDN 150 can use an initial MTU parameter value that is a high value and work toward lower MTU parameter values for each node on the transmission path. The home agent LMA/PDN 150 and/or the foreign agent MAG/SGW 130 then sets its MTU size based on this lowest maximum transmission unit for all the nodes on the transmission path, so that transmission packets processed by the home agent LMA/PDN 150 and/or foreign agent MAG/SGW 130, respectively, will be initially fragmented into a size that will not require any further internal processing or fragmentation by the intermediate processing entities and routers on the transmission path. This will eliminate the need for further fragmentation processing along the transmission path, which will result in less processing delays and system resource usage and greater transmission throughput on the system.

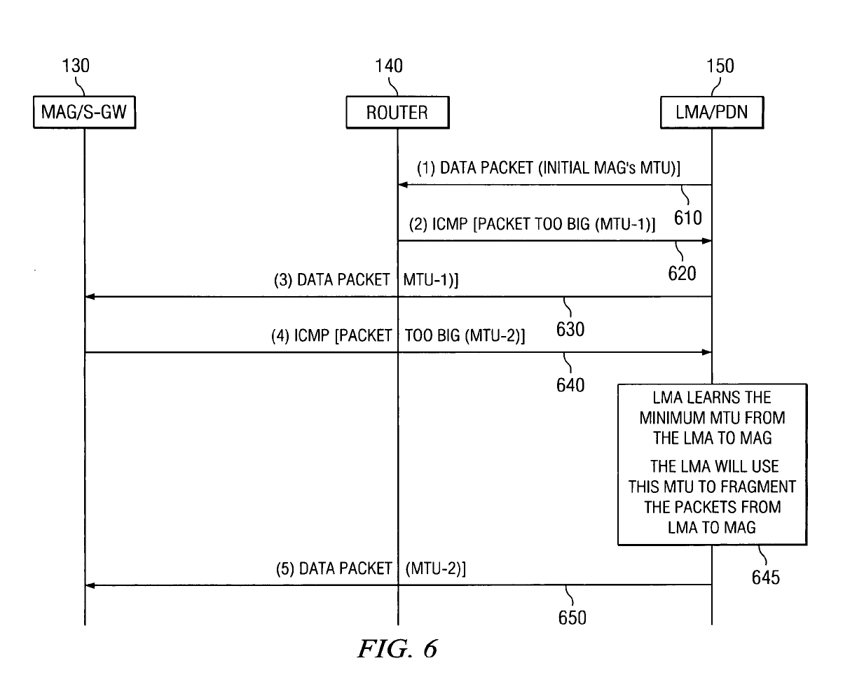

As an alternative embodiment shown in FIG. 6, the home agent LMA/PDN 150 may determine what the lowest MTU value for intermediate router 140 by sending a data packet message 610 to the intermediate router 140, where the data packet size corresponds to the initial MTU parameter value of the maximum transmission unit (MTU). This data packet size and initial MTU value may be received from the foreign agent MAG/SGW 130, or it may be set as a predetermined high MTU value.

The intermediate router 140 responds to the home agent LMA/PDN 150 with response (“packet too big”) message 620 if the data packet size of message 610 is greater than the MTU value that can be accommodated by the intermediate router without requiring that intermediate router to further fragment the transmission packet during processing and transmission. If the home agent LMA/PDN 150 receives this type of response 620, it will re-send its data packet transmission message 610 with a smaller data packet size. If the data packet size in the message 610 is equal to or less than MTU value that can be accommodated by the intermediate router 140 without requiring that intermediate router to further fragment the transmission packet during processing and transmission, the intermediate router 140 will not send a response message 620 to the home agent LMA/PDN 150. In this manner, the home agent LMA/PDN 150 will be able to determine the lowest MTU value setting for the intermediate router 140 when it does not receive a response message 620 from any intermediate router 140.

After not receiving a “packet too big” (PTB) response 620 from the intermediate router 140, the home agent LMA/PDN 150 will transmit similar data packet message 630 to the other nodes on the transmission path, such as to the foreign agent MAG/SGW 130 in data packet message 630. The foreign agent MAG/SGW 130 responds to the home agent LMA/PDN 150 with a “packet too big” (PTB) response message 640 if the data packet size in the request message 630 is greater than the MTU value that can be accommodated by the foreign agent MAG/SGW 130 without requiring that foreign agent MAG/SGW 130 to further fragment the transmission packet during processing and transmission. If the home agent LMA/PDN 150 receives a “packet too big” (PTB) response message 640, it will re-send its data packet message 630 with a lower data packet size.

If the data packet size in the transmission 630 is equal to or less than lowest MTU value that can be accommodated by the foreign agent MAG/SGW 130 without requiring that foreign agent MAG/SGW 130 to further fragment the transmission packet during processing and transmission, the intermediate router 140 will not send PTB (“packet too big”) response message 640 to the home agent LMA/PDN 150. Otherwise, the foreign agent MAG/SGW 130 will respond with a PTB response 640. In this manner, the home agent LMA/PDN 150 will be able to determine the lowest MTU value for the foreign agent MAG/SGW 130 path when it does not receive a response 640 from the foreign agent MAG/SGW 130.

After sending out data packets of various sizes to the nodes on the transmission path, the home agent LMA/PDN 150 will be able to determine the lowest maximum MTU value for all the nodes on the transmission path when it does not receive a response from the foreign agent MAG/SGW 130 or any other intermediate routers 140 on the transmission path. The home agent LMA/PDN 150 can start with a high data packet size for these transmissions and reduce the data packet size to determine the lowest maximum transmission unit (MTU) size accommodated by all nodes on the transmission path.

The home agent LMA/PDN 150 and/or the foreign agent MAG/SGW 130 then sets its MTU size setting based on this lowest maximum transmission unit (MTU) size for each of the nodes on the transmission path, so that transmission packets processed by the home agent LMA/PDN 150 and/or foreign agent MAG/SGW 130, respectively, will be fragmented into a size that will not require any further processing or fragmentation by the other processing entities and intermediate routers on the transmission path. The home agent LMA/PDN 150 may send the lowest MTU size to the foreign agent MAG/SGW 130 in message 650, or may send regular data packets to the foreign agent MAG/SGW 130 in step 650. This will eliminate the need for further fragmentation processing along the transmission path, which will result in less processing delays and system resource usage and greater transmission throughput on the system.

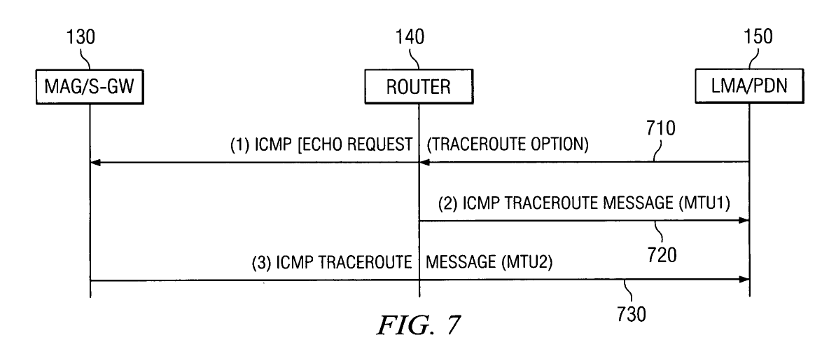

As a further embodiment, a traceroute message is used to determine the lowest MTU value for the nodes on the transmission path is shown in FIG. 7. The home agent LMA/PDN 150 sends a traceroute echo request message 710 to the foreign agent MAG/SGW 130 and each intermediate router 140 in the transmission path. The request message 710 includes a request to each of the foreign agent MAG/SGW 130 and intermediate router 140 in the transmission path, said request that each of these entities send the home agent LMA/PDN 150 the maximum transmission unit (MTU) size assigned to each foreign agent MAG/SGW 130 and/or intermediate router 140 in the transmission path. The MTU assigned to each entity is the maximum size of packet that can be received and processed by that entity (e.g. foreign agent MAG/SGW 130 or intermediate router 140) without requiring that entity to further fragment the transmission packet during processing and transmission.

The home agent MAG/SGW 130 receives responses 720 from the intermediate router 140 and responses 730 from the foreign agent MAG/SGW 130 to the requests 710, which responses include the maximum transmission unit (MTU) size assigned to each foreign agent MAG/SGW 130 and/or intermediate router 140 in the transmission path, respectively. The home agent MAG/SGW 130 accumulates maximum transmission unit (MTU) information from messages 720 and 730 transmitted from the foreign agent MAG/SGW 130 and/or intermediate router 140, and uses the accumulated MTU information to calculate the lowest maximum transmission unit (MTU) for all the nodes on the transmission path. The home agent LMA/PDN 150 can also send the foreign agent MAG/SGW 130 (and other nodes on the transmission path) a message, which includes the lowest maximum transmission unit (MTU) for the nodes on the transmission path.

The home agent LMA/PDN 150 and/or the foreign agent MAG/SGW 130 then sets its MTU size based on this lowest maximum transmission unit for all the nodes on the transmission path, so that transmission packets processed by the home agent LMA/PDN 150 and/or foreign agent MAG/SGW 130, respectively, will be fragmented into a size that will not require any further processing or fragmentation by the intermediate entities and routers on the transmission path. This will eliminate the need for intermediate fragmentation processing along the transmission path, which will result in less processing delays and system resource usage and greater transmission throughput on the system.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, we claim:

1. A method for discovering the lowest maximum transmission unit setting for one or more nodes on a transmission path from a home network to a mobile node, comprising the steps of:
receiving an update message at a home agent on the home network, said update message containing the maximum transmission unit setting for a node on the transmission path sending the update message, said maximum transmission unit setting indicates the maximum size of transmission packets that can be processed by the node without further fragmentation of the transmission packet at the node;
accumulating update messages at the home agent on the home network having the maximum transmission unit setting for one or more nodes on the transmission path between the home network and the mobile node;
calculating the lowest maximum transmission unit setting from the maximum transmission unit settings accumulated from the update messages received at the home agent;
using the lowest maximum transmission unit setting as the maximum transmission unit setting for one or more nodes on the transmission path so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

2. The method in claim 1 wherein the home agent is a local mobility anchor entity.

3. The method in claim 1 wherein one node sending the update message is a serving gateway entity.

4. The method in claim 1 wherein one node sending the update message is an intermediate router entity.

5. A method for discovering the lowest maximum transmission unit setting for one or more nodes on a transmission path from a home network to a mobile node, comprising the steps of:
transmitting an echo message from a home agent on the home network, said echo message having a maximum transmission unit parameter, said maximum transmission unit parameter value indicating the maximum size of transmission packets that can be processed by a node without further fragmentation of the transmission packet at the node;
receiving an echo response message at the home agent in response to the echo message if the maximum transmission unit parameter exceeds the maximum transmission unit setting for one or more nodes on the transmission path between the home network and the mobile node;
transmitting a second message from the home agent with a lower maximum transmission unit parameter after receiving said echo response message;
accumulating the maximum transmission unit setting for each of one or more nodes on the transmission path after transmitting echo messages with maximum transmission unit parameters but not receiving an echo response, said maximum transmission unit setting for any particular node on the transmission path assumed from the maximum transmission unit parameter value in the latest echo message that was not responded to by each of said one or more nodes;
calculating the lowest maximum transmission unit setting for the one or more nodes in the transmission path based on the accumulated maximum transmission unit settings;
using the lowest maximum transmission unit setting as the maximum transmission unit setting at one or more nodes on the transmission path so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

6. The method in claim 5 wherein the home agent is a local mobility anchor entity.

7. The method in claim 5 wherein one node sending the update message is a serving gateway entity.

8. The method in claim 5 wherein one node sending the update message is an intermediate router entity.

9. A method for discovering the lowest maximum transmission unit setting for one or more nodes on a transmission path from a home network to a mobile node, comprising the steps of:
transmitting an data packet message from a home agent on the home network, said data packet message having a size correlated to a maximum transmission unit parameter, said maximum transmission unit parameter value indicating the maximum size of transmission packets that can be processed by a node without further fragmentation of the transmission packet at the node;
receiving an response message at the home agent in response to the data packet message if the data packet size of the data packet message exceeds the maximum transmission unit setting for one or more nodes on the transmission path between the home network and the mobile node;
transmitting a second data packet message from the home agent with a lower data packet size after receiving said response message;
accumulating the maximum transmission unit settings for each of one or more nodes on the transmission path after transmitting data packet messages but not receiving a response message, said maximum transmission unit setting for any particular node on the transmission path assumed from the data packet size of the data packet message that was not responded to by each of said one or more nodes;
calculating the lowest maximum transmission unit setting for the one or more nodes in the transmission path based on the accumulated maximum transmission unit settings;
using the lowest maximum transmission unit setting as the maximum transmission unit setting at one or more nodes on the transmission path so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

10. The method in claim 9 wherein the home agent is a local mobility anchor entity.

11. The method in claim 9 wherein one node sending the update message is a serving gateway entity.

12. The method in claim 9 wherein one node sending the update message is an intermediate router entity.

13. A method for discovering the lowest maximum transmission unit setting for one or more nodes on a transmission path from a home network to a mobile node, comprising the steps of:
transmitting a request message from a home agent on the home network, said echo request message requesting the maximum transmission unit setting for one or more nodes on the transmission path, said maximum transmission unit setting indicates the maximum size of transmission packets that can be processed by the node without further fragmentation of the transmission packet at the node
receiving a response message at a home agent on the home network, said response message containing the maximum transmission unit setting for the node on the transmission path sending the response message,
accumulating response messages at the home agent on the home network having the maximum transmission unit setting for one or more nodes on the transmission path between the home network and the mobile node;
calculating the lowest maximum transmission unit setting from the maximum transmission unit settings accumulated from the response messages received at the home agent;
using the lowest maximum transmission unit setting as the maximum transmission unit setting for one or more nodes on the transmission path so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

14. The method in claim 13 wherein the home agent is a local mobility anchor entity.

15. The method in claim 13 wherein one node sending the update message is a serving gateway entity.

16. The method in claim 13 wherein one node sending the update message is an intermediate router entity.

17. A communications network that discovers the lowest maximum transmission unit setting for one or more nodes on a transmission path from a home network to a mobile node, comprising:
a home agent on the home network that receives an update message containing the maximum transmission unit setting for a node on the transmission path sending the update message, said maximum transmission unit setting indicates the maximum size of transmission packets that can be processed by the node without further fragmentation of the transmission packet at the node,
said home agent accumulates said update messages having the maximum transmission unit setting for one or more nodes on the transmission path between the home network and the mobile node and calculates the lowest maximum transmission unit setting from the maximum transmission unit settings accumulated from the update messages received;
the lowest maximum transmission unit setting is used by one or more nodes on the transmission path as the maximum transmission unit setting so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

18. The network in claim 17 wherein the home agent is a local mobility anchor entity.

19. The network in claim 17 wherein one node sending the update message is a serving gateway entity.

20. The network in claim 17 wherein one node sending the update message is an intermediate router entity.

21. A communications network that discovers the lowest maximum transmission unit setting for one or more nodes on a transmission path from a home network to a mobile node, comprising:
a home agent on the home network that transmits an echo message having a maximum transmission unit parameter, said maximum transmission unit parameter value indicating the maximum size of transmission packets that can be processed by a node without further fragmentation of the transmission packet at the node, said home agent receives an echo response message if the maximum transmission unit parameter exceeds the maximum transmission unit setting for one or more nodes on the transmission path between the home network and the mobile node, and said home agent transmits a second message with a lower maximum transmission unit parameter after receiving said response message;
said home agent accumulates the maximum transmission unit setting for each of one or more nodes on the transmission path after said home agent transmits echo messages with maximum transmission unit parameters but does not receive an echo response, said maximum transmission unit setting for any particular node on the transmission path assumed from the maximum transmission unit parameter value in the latest echo message that was not responded to by each of said one or more nodes;
said home agent calculates the lowest maximum transmission unit setting for the one or more nodes in the transmission path based on the accumulated maximum transmission unit settings, said lowest maximum transmission unit setting is used on one or more nodes on the transmission path as the maximum transmission unit setting so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

22. The network in claim 21 wherein the home agent is a local mobility anchor entity.

23. The network in claim 21 wherein one node sending the update message is a serving gateway entity.

24. The network in claim 21 wherein one node sending the update message is an intermediate router entity.

25. A communications network that discovers the lowest maximum transmission unit setting for one or more nodes on a transmission path from a home network to a mobile node, comprising:
a home agent on the home network that transmits a data packet message having data packet size correlated to a maximum transmission unit value, said maximum transmission unit value indicating the maximum size of transmission packets that can be processed by a node without further fragmentation of the transmission packet at the node, said home agent receives a response message if the data packet size exceeds the maximum transmission unit setting for one or more nodes on the transmission path between the home network and the mobile node, and said home agent transmits a second data packet message with a smaller data packet size after receiving said response message;
said home agent accumulates the maximum transmission unit setting for each of one or more nodes on the transmission path after said home agent transmits data packet messages with data packet sizes correlated to maximum transmission unit values but does not receive a response message, said maximum transmission unit setting for any particular node on the transmission path assumed from the data packet size in the latest data packet message that was not responded to by each of said one or more nodes;
said home agent calculates the lowest maximum transmission unit setting for the one or more nodes in the transmission path based on the accumulated maximum transmission unit settings, said lowest maximum transmission unit setting is used on one or more nodes on the transmission path as the maximum transmission unit setting so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

26. The network in claim 25 wherein the home agent is a local mobility anchor entity.

27. The network in claim 25 wherein one node sending the update message is a serving gateway entity.

28. The network in claim 25 wherein one node sending the update message is an intermediate router entity.

29. A communications network that discovers the lowest maximum transmission unit setting for one or more nodes on a transmission path from a home network to a mobile node, comprising:
a home agent on the home network that transmits a request message from a home agent on the home network, said request message requesting the maximum transmission unit setting for one or more nodes on the transmission path, said maximum transmission unit setting indicating the maximum size of transmission packets that can be processed by the node without further fragmentation of the transmission packet at the node
said home agent receives a response message containing the maximum transmission unit setting for the node on the transmission path sending the response message, accumulates said response messages for one or more nodes on the transmission path between the home network and the mobile node, and calculates the lowest maximum transmission unit setting from the maximum transmission unit settings accumulated from the response messages received at the home agent;
said lowest maximum transmission unit setting is used as the maximum transmission unit setting for one or more nodes on the transmission path so allow for initial fragmentation of transmission packets into sizes that are less than or equal to the lowest maximum transmission unit setting for the one or more nodes on the transmission path, which will reduce the internal fragmentation of transmission packets on nodes that are located on the transmission path.

30. The network in claim 29 wherein the home agent is a local mobility anchor entity.

31. The network in claim 29 wherein one node sending the update message is a serving gateway entity.

32. The network in claim 29 wherein one node sending the update message is an intermediate router entity.
